(19) United States
(12) Patent Application Publication
(10) Pub. No.: US 2019/0246030 A1
(43) Pub. Date: Aug. 8, 2019

(54) BUOYANT CAMERA SYSTEM AND METHOD

(71) Applicant: Likaa H. Kambar, Gilbert, AZ (US)

(72) Inventor: Likaa H. Kambar, Gilbert, AZ (US)

(21) Appl. No.: 16/270,359

(22) Filed: Feb. 7, 2019

Related U.S. Application Data
(60) Provisional application No. 62/627,622, filed on Feb. 7, 2018.

(51) Int. Cl. H04N 5/232; G03B 17/08; H04N 5/225

(52) U.S. Cl. CPC H04N 5/23206; H04N 5/23216; H04N 5/232933; H04N 5/2252; G03B 17/08

(57) ABSTRACT

A buoyant camera system is disclosed herein. The buoyant camera system comprises a buoyant body having a top-side and a bottom-side. A top-camera is attached to the top-side of the buoyant body. The top-camera is protected by a top-dome that is configured to protect the top-camera from fluid. A bottom-camera is attached to the bottom-side of the buoyant body. The bottom-camera is protected by a bottom-dome that is configured to protect the bottom-camera from fluid. A controller is disposed within the buoyant body. The controller is in electrical communication with the top-camera and the bottom-camera. A program may direct the controller to be in wireless communication with the mobile device. The program may be configured to send and receive audio and video to the mobile device.

### CROSS-REFERENCE TO RELATED APPLICATION(S)

The present application is related to and claims priority to U.S. Provisional Patent Application No. 62/627,622 filed Feb. 7, 2018, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of safety systems of existing art and more specifically relates to a surveillance system.

### RELATED ART

Presently safety protocols at pools are limited to a very few rules. General rules include not running on potential slippery surface and not swimming directly after consuming food. Means to enforce these rules are limited to lifeguards, signs, and stories from childhood. In some instances, cameras will be placed to watch over a pool area. Still with trained lifeguards on duty, or a streaming camera system, pool drowning incidents frequently occur. Many drowning incidents happen in residential pools where constant monitoring is not an economically feasible option. Crushing tragedies where small children and loved ones drown in a residential pool are unfortunate and avoidable.

Presently existing pool monitoring systems may comprise cameras that capture videos of the surrounding area. These camera systems have failed to provide adequate reporting technologies due to their statically fixed location. The present technologies ignore the fact that a direct line of sight is required to fulfill the intended use of the camera. Typically, these monitoring systems are used to detect unwanted visitors and send an alert to a property manager. Statically fixed pool monitoring cameras provide very little warning of impending drowning tragedies until it is too late.

U.S. Pat. No. 5,325,086 to Raymond F. Thomas relates to a wave responsive alarm for swimming pool. The described wave responsive alarm for swimming pool includes a safety device which is responsive to excessive wave motion of a body of water includes a housing having a pivotable telescoping arm connected thereto. A pair of spaced apart probes are mounted on the end of the arm. The probes are connected to a control circuit located in the housing. The control circuit measures the electrical resistance between the two probes, which is normally an open circuit. In use, the arm is manipulated so as to position the probes a desired distance above the normal water level when no one is in the pool. Thus, the space separating the two probes is normally not bridged by water from the pool. When a person enters the pool, however, larger waves are created. These larger waves splash across the probes, bridging the space therebetween. As a result, the electrical resistance between the probes decreases. The control circuit is responsive to this change for generating an alarm. The safety device may also include a pressure responsive switch secured to a step of a ladder in the pool. The pressure switch is also connected by wires to the control circuit. When a person using the ladder steps on the pressure switch, the control circuit is activated to generate the alarm.

### SUMMARY OF THE INVENTION

In view of the foregoing disadvantages inherent in the known surveillance system art, the present disclosure provides a novel buoyant camera system and method. The general purpose of the present disclosure, which will be described subsequently in greater detail, is to provide a buoyant camera system and method.

A buoyant camera system is disclosed herein. The buoyant camera system comprises a buoyant body having a top-side and a bottom-side. A top-camera is attached to the top-side of the buoyant body. The top-camera is protected by a top-dome that is configured to protect the top-camera from fluid. A bottom-camera is attached to the bottom-side of the buoyant body. The bottom-camera is protected by a bottom-dome that is configured to protect the bottom-camera from fluid. A controller is disposed within the buoyant body. The controller is in electrical communication with the top-camera and the bottom-camera. A non-transitory com computer-readable medium having stored therein a program for causing a computer to execute a process of controlling a mobile device to receive instructions from the controller. The program may direct the controller to be in wireless communication with the mobile device. The program may be configured to send and receive audio and video to the mobile device.

According to another embodiment, a method of using a buoyant camera system is also disclosed herein. The method of using a buoyant camera system includes providing the above-described buoyant camera system, placing the buoyant camera system in water, executing an application on a mobile device, and optionally, rotating the top-camera and the bottom-camera.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a buoyant camera system and method, constructed and operative according to the teachings of the present disclosure.

FIG. 1 is a perspective view of the buoyant camera system during an ‘in-use’ condition, according to an embodiment of the disclosure.

FIG. 2 is a side perspective view of the buoyant camera system of FIG. 1, according to an embodiment of the present disclosure.

FIG. 3 is a top perspective view of the buoyant camera system of FIG. 1, according to an embodiment of the present disclosure.

FIG. 4 is a perspective view of the mobile device of the buoyant camera system of FIG. 1, according to an embodiment of the present disclosure.

FIG. 5 is a flow diagram illustrating a method of use for using a buoyant camera system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a surveillance system and more particularly to a buoyant camera system and method as used to improve the monitoring of children in a pool.

Generally, the buoyant camera system is an aquatic sentry drone that will assist homeowners in keeping watch over their home pools. The buoyant camera system enables pool owners' immediate visibility to their aquatic environment through their mobile device. The components that comprise the buoyant camera system are designed utilizing industry leading techniques for durability as well as versatility for a range of environments and stresses. The buoyant camera system provides an autonomous means to notify homeowners that a child, pet, or family member is submerged in water. The buoyant camera system was designed to be used in conjunction with existing pool fences and safety protocols.

The buoyant camera system comprises of a buoyant body having a camera disposed on both the top, and the bottom. The system is designed to float in a pool and monitor any activity. The system may include photovoltaic cells, allowing for a longer duration of electrical components functionality. The buoyant camera system is designed to communicate wirelessly to an application on a mobile device. The application is configured to receive and display video signals from the camera system. The application may also be designed to send and receive audio to and from the buoyant camera system. This functionality allows for the buoyant camera system to serve as a direct communication device between users.

Optional integrated features to the buoyant camera system are paralleled with conceived and available technologies. Integration of voice recognition services may be considered. Voice recognition, in combination with means of sending and receiving audio, may allow the buoyant camera system to serve both as a digital assistant, and an entertainment system. The buoyant camera system and associated program accommodates scalable technologies including thermal imaging, and digital recognition algorithms. The scalable technologies allow the buoyant camera system to be used for residential and commercial purposes.

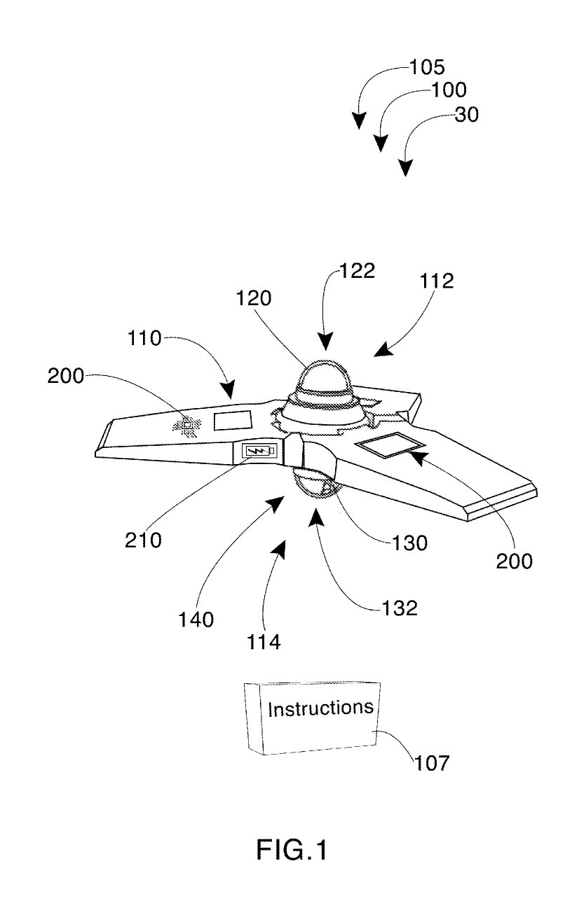

Referring now more specifically to the drawings by numerals of reference, there is shown in FIGS. 1-4, various views of a buoyant camera system 100.

FIG. 1 shows a buoyant camera system, according to an embodiment of the present disclosure. Here, the buoyant camera system 100 may be beneficial for use by a user to monitor an aqueous environment. The buoyant camera system 100 includes a buoyant body 110, the buoyant body 110 includes a top-side 112 and a bottom-side 114. A top-camera 120 is attached to the top-side 112 of the buoyant body 110. The top-camera 120 is protected by a top-dome 122 configured to protect the top-camera 120 from fluid. A bottom-camera 130 is attached to the bottom-side 114 of the buoyant body 110. The bottom-camera 130 is protected by a bottom-dome 132 configured to protect the bottom-camera 130 from fluid. The top-dome 122 and the bottom-dome 132 are made from translucent material, enabling the passage of light therethrough. The controller 200 is disposed within the buoyant body 110 and in electrical communication with the top-camera 120 and the bottom-camera 130.

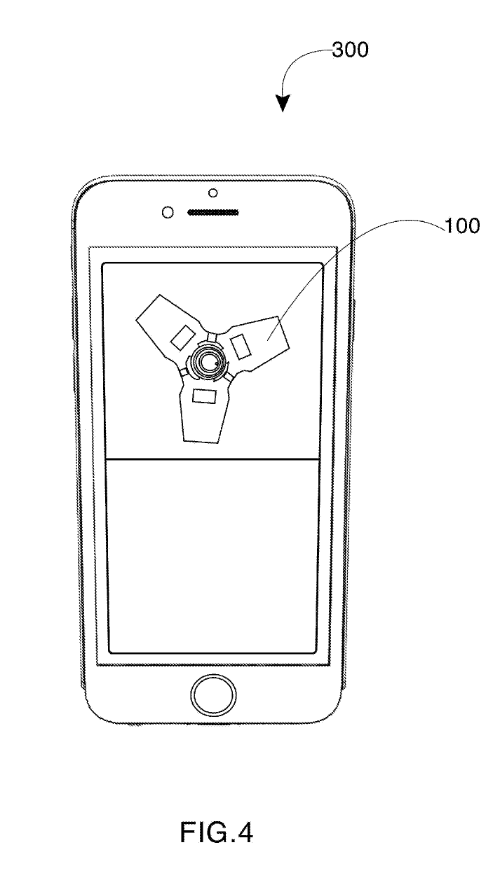

A non-transitory computer-readable medium, may be included. The non-transitory computer-readable medium has a stored program for causing a computer to execute a process of controlling a mobile device 300 (FIG. 4) to receive instructions from the controller (not shown). A program may be designed to send and receive communications with a mobile device 300 (FIG. 4). In one embodiment, the program is an application capable of running on an operating system of a mobile device 300 (FIG. 4). In this embodiment the mobile device 300 (FIG. 4) may be used to operate the buoyant camera system 100. The non-transitory computer-readable medium may be integrated with the controller 200 as stored memory capable of embedded programming. The buoyant camera system 100 may include a photovoltaic array 200 disposed on the top-side 112 of the body 110. In one embodiment, the photovoltaic array 200 may be used to power the controller 200. In another embodiment, the photovoltaic array 200 may be used to charge a rechargeable battery 210.

According to one embodiment, the buoyant camera system 100 may be arranged as a kit 105. In particular, the buoyant camera system 100 may further include a set of instructions 107. The instructions 107 may detail functional relationships in relation to the structure of the buoyant camera system 100 such that the buoyant camera system 100 can be used, maintained, or the like, in a preferred manner.

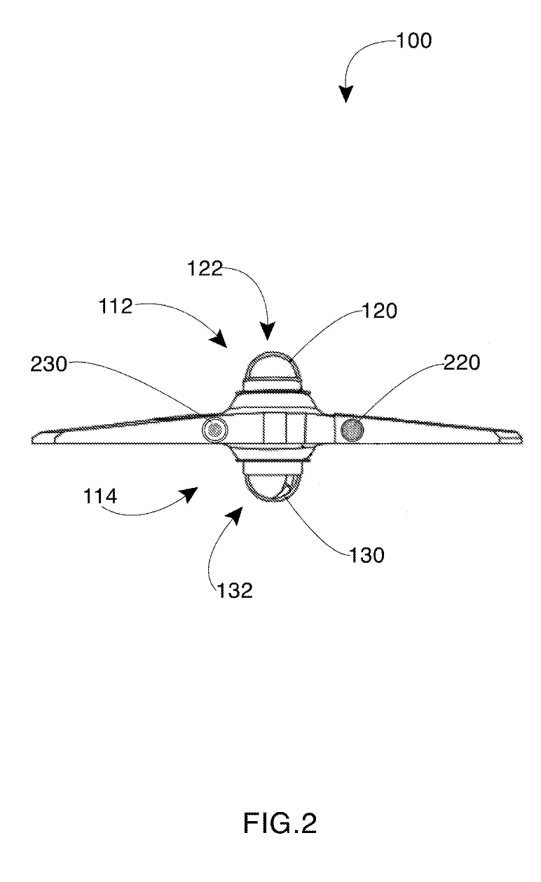

FIG. 2 shows the buoyant camera system of FIG. 1, according to an embodiment of the present disclosure. As above, the buoyant camera system 100 may include a buoyant body 110 having a top-side 112 and a bottom-side 114. A top-camera 120 is attached to the top-side 112 of the buoyant body 110. The top-camera 120 is protected by a top-dome 122 configured to protect the top-camera 120 from fluid. A bottom-camera 130 is attached to the bottom-side 114 of the buoyant body 110. The bottom-camera 130 is protected by a bottom-dome 132 configured to protect the bottom-camera 130 from fluid. The controller 200 (FIG. 1) is disposed within the buoyant body 110 and in electrical communication with the top-camera 120 and the bottom-camera 130. A microphone 220 may be included and connected to the controller (not shown) of the buoyant camera system 100. The buoyant camera system 100 may be operated through voice commands. A user may speak keywords to execute custom programmed instructions, such as contacting emergency services and making and receiving a telephone call. A speaker 230 may also be integrated with the buoyant camera system 100. The speaker may be useful for communications, entertainment, and audible alerts. The buoyant camera system 100 may include any capacity of wireless transceivers. The transceivers included with the buoyant camera system 100 may be configured for the 2.4 GHz frequency for mating with standardized wireless technologies.

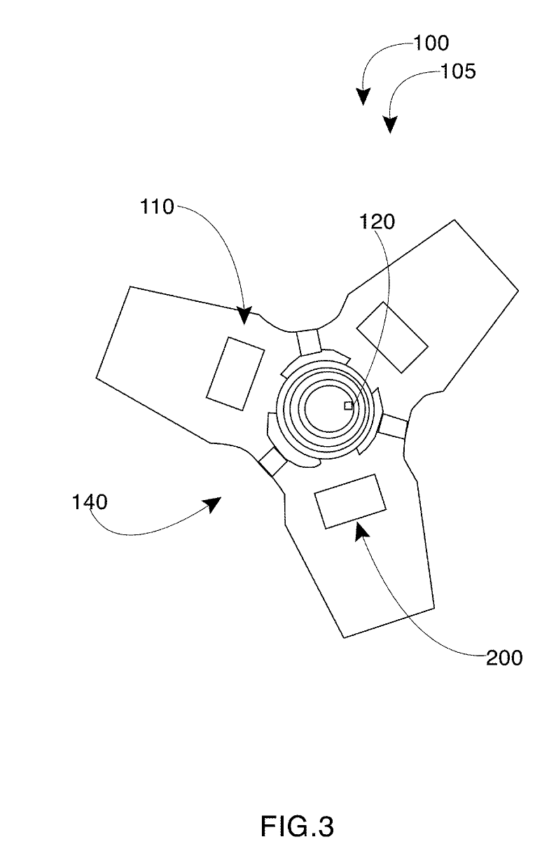

FIG. 3 is another view of the buoyant camera system 100 of FIG. 1, according to an embodiment of the present disclosure. The buoyant camera system 100 includes a buoyant body 110 having a top-side 112 and a bottom-side 114. A top-camera 120 is attached to the top-side 112 of the buoyant body 110. The top-camera 120 is configured to rotate 360 degrees. The top-camera 120 is protected by a top-dome 122 configured to protect the top-camera 120 from fluid. A bottom-camera 130 is attached to the bottom-side 114 of the buoyant body 110. In some embodiments, the cameras have thermal imaging capabilities. The bottom-camera 130 is protected by a bottom-dome 132 configured to protect the bottom-camera 130 from fluid. The controller 200 (FIG. 1) is disposed within the buoyant body 110 and substantially protected from impact and weather. The controller 200 (FIG. 1) may further enable the rotatability of top-camera 120. The top-camera 120 is configured to rotate 360 degrees. The controller 200 (FIG. 1) may also enable the rotatability of the bottom-camera 130. The bottom-camera 130 is also configured to rotate 360 degrees. The top-dome 122 does not impede the rotation of the top-camera 120. The bottom-dome 132 does not impede the rotation of the of bottom-camera 130. The rotating functionality of the two cameras may be controlled wirelessly though the internet on a mobile device 300 (FIG. 4). The mobile device 300 (FIG. 4) may be also programmed to receive audio signal from a microphone 220 (FIG. 2) mounted on the body 110 of the buoyant camera system 100.

FIG. 4 is an application view of the buoyant camera system 100 of FIG. 1, according to an embodiment of the present disclosure. As shown, the buoyant camera system 100 includes a non-transitory computer-readable medium having stored therein a program for causing a computer to execute a process of controlling a mobile device 300 to receive instructions from the controller 200 (FIG. 1). By design, the non-transitory computer-readable medium may be included as an integral part of the buoyant camera system 100, and an associated mobile device 300. The mobile device 300 may be a phone, a tablet, and any further conceived means of receiving a signal from the controller 200 (FIG. 1). The process on the non-transitory computer-readable medium may include instructions to receiving video signal from the top-camera 120 (FIG. 1). The process on the non-transitory computer-readable medium may further include instructions to display video signal from the top-camera 120 (FIG. 1). These instructions may be executed from both the controller 200 (FIG. 1) of the buoyant camera system 100, and from the mobile device 300. The process on the non-transitory computer-readable medium may include instructions for receiving video signal from the bottom-camera 130 (FIG. 1). Accordingly, the process on the non-transitory computer-readable medium may include instructions to display video signal from the bottom-camera 130 (FIG. 1). Further featured, the non-transitory computer-readable medium may include instructions to send and receive an audio signal. The audio signal may be received by the controller 200 (FIG. 1) through a microphone 220 (FIG. 2) and subsequently sent to the mobile device 300. The mobile device 300 may transmit audio signals to the buoyant camera system 100 for processing through a speaker 230 (FIG. 2). The non-transitory computer readable medium may further include instructions to communicate with a mobile network. These instructions may be directed to the mobile device 300 to connect to a mobile network. Alternately, the instructions may enable the controller 200 (FIG. 1) of the buoyant camera system 100 to connect to a mobile network directly.

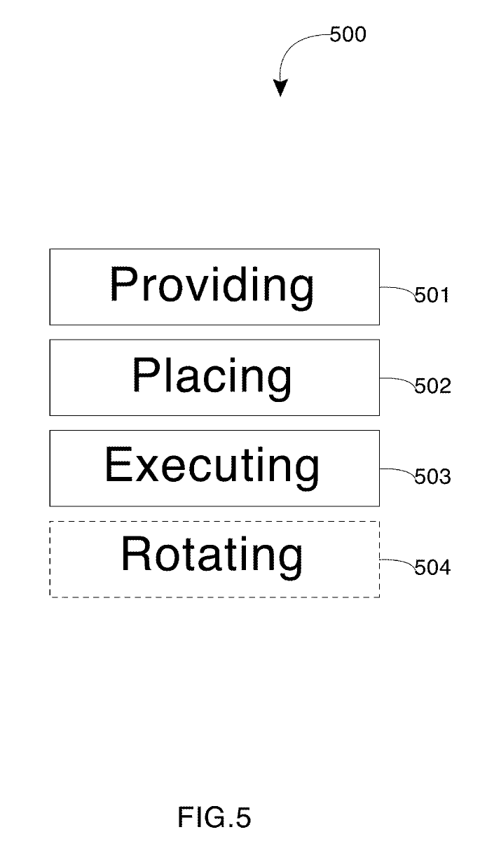

FIG. 5 is a flow diagram illustrating a method for using a buoyant camera system, according to an embodiment of the present disclosure. In particular, the method for using a buoyant camera system 500 may include one or more components or features of the buoyant camera system 100 as described above. As illustrated, the method for using a buoyant camera system 500 may include the steps of: step one 501, providing a buoyant camera system; step two 502, placing said buoyant camera system in water; step three 503, executing an application on a mobile device; and step four 504, rotating a top-camera and a bottom-camera.

It should be noted that step 504 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for monitoring children in a pool, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A buoyant camera system for use in water, the buoyant camera system comprising:
a buoyant body, said buoyant body including a top-side and a bottom-side;
a top-camera, said top-camera being attached to said top-side of said buoyant body, said top-camera being protected by a top-dome configured to protect said top-camera from fluid;
a bottom-camera, said bottom-camera being attached to said bottom-side of said buoyant body, said bottom-camera being protected by a bottom-dome configured to protect said bottom camera from fluid;
a controller, said controller being disposed within said buoyant body, said controller being in electrical communication with said top-camera and said bottom-camera; and
a non-transitory computer-readable medium having stored therein a program for causing a computer to execute a process of controlling a mobile device to receive instructions from said controller.

2. The buoyant camera system of claim 1, further including a photovoltaic array.

3. The buoyant camera system of claim 1, further including a rechargeable battery.

4. The buoyant camera system of claim 1, further including a microphone.

5. The buoyant camera system of claim 1, further including a speaker

6. The buoyant camera system of claim 5, wherein said controller includes a wireless transceiver.

7. The buoyant camera system of claim 1, wherein said wireless transceiver is configured to communicate on the 2.4 GHz frequency.

8. The buoyant camera system of claim 1, further comprising a plurality of buttons.

9. The buoyant camera system of claim 1, wherein said process on said non-transitory computer-readable medium includes instructions to receiving video signal from said top-camera.

10. The buoyant camera system of claim 1, wherein said process on said non-transitory computer-readable medium includes instructions to display video signal from said top-camera.

11. The buoyant camera system of claim 1, wherein said process on said non-transitory computer-readable medium includes instructions to receive video signal from said bottom-camera.

12. The buoyant camera system of claim 1, wherein said process on said non-transitory computer-readable medium includes instructions to display video signal from said bottom-camera.

13. The buoyant camera system of claim 1, wherein said process on said non-transitory computer-readable medium includes instructions to receive video signal.

14. The buoyant camera system of claim 1, wherein said process on said non-transitory computer-readable medium includes instructions to communicate with a mobile network.

15. The buoyant camera system of claim 1, wherein said top-camera is pivotably coupled to said buoyant body, said top-camera being configured to rotate 360 degrees.

16. The buoyant camera system of claim 1, wherein said bottom-camera is pivotably coupled to said buoyant body, said bottom-camera being configured to rotate 360 degrees.

17. A buoyant camera system comprising:
a buoyant body, said buoyant body includes a top-side and a bottom-side;
a top-camera, said top-camera is attached to said top-side of said buoyant body, said top-camera is protected by a top-dome configured to protect said top-camera from fluid;
a bottom-camera, said bottom-camera is attached to said bottom-side of said buoyant body, said bottom-camera is protected by a bottom-dome configured to protect said bottom camera from fluid;
a controller, said controller is disposed within said buoyant body and in electrical communication with said top-camera and said bottom-camera;
a non-transitory computer-readable medium having stored therein a program for causing a computer to execute a process of controlling a mobile device to receive instructions from said controller;
further including a photovoltaic array;
further including a rechargeable battery;
further including a microphone;
further including a speaker;
wherein said controller includes a wireless transceiver;
wherein said wireless transceiver is configured to communicate on the 2.4 GHz frequency;
further comprising a plurality of buttons;
wherein said process on said non-transitory computer-readable medium includes instructions to receiving video signal from said top-camera;
wherein said process on said non-transitory computer-readable medium includes instructions to display video signal from said top-camera;
wherein said process on said non-transitory computer-readable medium includes instructions to receiving video signal from said bottom-camera;
wherein said process on said non-transitory computer-readable medium includes instructions to display video signal from said bottom-camera;
wherein said process on said non-transitory computer-readable medium includes instructions to receive video signal;
wherein said process on said non-transitory computer-readable medium includes instructions to communicate with a mobile network;
wherein said top-camera is configured to rotate 360 degrees; and
wherein said bottom-camera is configured to rotate 360 degrees.

18. The buoyant camera system of claim 17, further comprising set of instructions; and
wherein the buoyant camera system is arranged as a kit.

19. A method of using a buoyant camera system, the method comprising the steps of:
providing a buoyant camera system;
placing said buoyant camera system in water; and
executing an application on a mobile device.

20. The method of claim 19, further comprising the steps of
rotating a top-camera and a bottom-camera.
